(19) United States
(12) Patent Application Publication
(10) Pub. No.: US 2003/0078052 A1
(43) Pub. Date: Apr. 24, 2003

(54) Method and apparatus for sharing infrastructure between wireless network operators

(75) Inventors: Nissim Atias, Raanana (IL); Miguel Cizin, Raanana (IL)

Correspondence Address: John N. Anastasi, Wolf, Greenfield & Sacks, P.C., 600 Atlantic Avenue, Boston, MA, 02210, US

(73) Assignee: Celerica, Inc., Morristown, NJ

(21) Appl. No.: 10/255,147

(22) Filed: Sep. 25, 2002

Related U.S. Application Data
(63) Continuation-in-part of application No. 10/039,330, filed on Nov. 7, 2001.
(63) Continuation-in-part of application No. 09/863,162, filed on May 23, 2001.
(60) Provisional application No. 60/324,817, filed on Sep. 25, 2001.
(60) Provisional application No. 60/333,345, filed on Nov. 26, 2001.

(51) Int. Cl. H04B 10/00; H04Q 7/20

(52) U.S. Cl. 455/453; 359/145; 359/172

(57) ABSTRACT

An apparatus and methods for sharing communications infrastructure between multiple network operators. In one example, a shared network includes a first infrastructure of a first operator, a second infrastructure of a second operator, and a first remote antenna of the first operator disposed on the second infrastructure and coupled to the first infrastructure by a communication link. The communication link may be a wireless optical link between the first remote antenna and the first infrastructure.

### CROSS-REFERENCE TO RELATED APPLICATIONS

This application is a continuation-in-part of, and claims priority under 35 U.S.C. § 120 to, U.S. application Ser. No. 10/039,330 entitled “Optical Communication System,” filed Nov. 7, 2001, which is herein incorporated by reference, and is also a continuation-in-part of, and claims priority under 35 U.S.C. § 120 to, U.S. application Ser. No. 09/863,162 entitled “Cellular Base Station with Remote Antenna,” filed May 23, 2001, which is also herein incorporated by reference.. This application also claims priority under 35 U.S.C. § 119(e) to U.S. Provisional Application Serial No. 60/324,817, entitled “Swapping Antennas Between Cellular or any Wireless Network Operators,” filed Sep. 25, 2001 (not published), and U.S. Provisional Application Serial No. 60/333,345, entitled “Swapping Antennas Between Cellular or any Wireless Network Operators,” filed Nov. 26, 2001 (not published), which are both herein incorporated by reference in their entirety.

### BACKGROUND

1. Field of the Invention

The present invention is related to wireless communication networks, and in particular to sharing of network infrastructure among network operators.

2. Discussion of Related Art

In densely populated areas, for example, large cities, real estate is a scarce commodity, and it is becoming increasingly difficult to obtain permits on a timely basis to deploy cellular base stations and towers for cellular or other wireless communications networks. In rural areas, or other sparsely populated areas, real estate may be readily available, but installing base stations and towers and other network infrastructure is expensive, and may not be cost effective in areas where there are very few users. Thus, it is difficult and/or costly for network operators to increase coverage and or capacity, by, for example, adding additional cell sites.

### SUMMARY OF THE INVENTION

According to one embodiment, a method for adding capacity to a first network, comprises acts of operating a first remote antenna of a first operator on an infrastructure of a second operator, transmitting and receiving a wireless signal with the first remote antenna and transmitting a first signal to the first remote antenna from a first infrastructure of the first operator and providing the first signal from the first remote antenna to the first infrastructure.

According to another embodiment, a shared network comprises a first infrastructure of a first operator, a second infrastructure of a second operator, and a first remote antenna of the first operator operated on the second infrastructure and coupled to the first infrastructure by a communication link.

### BRIEF DESCRIPTION OF THE DRAWINGS

The foregoing and other features and advantages of the present invention will be apparent from the following non-limiting discussion of various embodiments and aspects thereof with reference to the accompanying drawings, in which like reference numerals refer to like elements throughout the different figures. The drawings are provided for the purposes of illustration and explanation, and are not intended as a definition of the limits of the invention. In the drawings,

FIG. 1 is a schematic block diagram of a portion of one embodiment of a shared network according to aspects of the invention;

FIGS. 2a and 2b are schematic block diagrams of one embodiment of link termination circuitry according to aspects of the invention; and

FIG. 3 is a schematic block diagram of a portion of another embodiment of a shared network according to aspects of the invention.

### DETAILED DESCRIPTION

The present invention relates to methods and apparatus for mutually sharing communications infrastructure among network operators, thereby enabling a network operator to enhance its network by adding capacity and coverage while minimizing the costs associated therewith. It is to be understood that the invention is not limited in its application to the details of construction and the arrangement of components set forth in the following description or illustrated in the drawings. Other embodiments and manners of carrying out the invention are possible. Also, it is to be understood that the phraseology and terminology used herein is for the purpose of description and should not be regarded as limiting. The use of “including,” “comprising,” or “having” and variations thereof is meant to encompass the items listed thereafter and equivalents thereof as well as additional items. In addition, it is to be appreciated that the term “network” refers to an interconnected collection of two or more network elements, which may be, for example, one or more user terminals, a base station, an antenna, and the like. It is to be understood that any of the network elements may be distributed network elements, and may be shared by one or more operators. The interconnection between the network elements may be made using any type of link known in the art, for example, wireless links, coaxial cable, optical fiber, twisted pair cables, wireless optical links, etc., or any combination of these types of links.

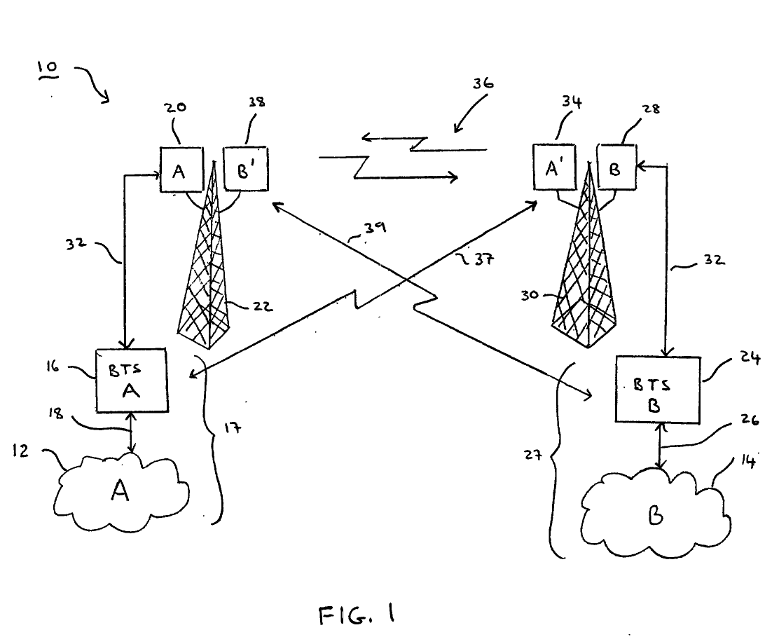

Referring to FIG. 1, there is illustrated a portion of a shared network 10 according to one embodiment of the invention. The shared network may include network elements forming parts of networks operated by at least two network operators. The shared network may include a first network 12 that may be operated by a first network operator, herein referred to as Operator A, and a second network 14 that may be operated by a second network operator, herein referred to as Operator B. It is to be appreciated that although the following embodiments of the invention will be discussed in terms of two network operators, the invention is not so limited, and the shared network 10 may include any number of cooperating network operators.

According to one embodiment, the first network 12 may include a first base station (BTS-A) 16 coupled to the first network 12 by a link 18 that may be any type of link, as discussed above. The first network 12 and BTS-A 16 may be referred to as a first backhaul structure 17, belonging to Operator A. The BTS-A 16 may be coupled to an antenna 20 that may be, for example, disposed on a tower 22 belonging to Operator A. The antenna 20 may broadcast radio frequency (RF) signals to, and receive RF signals from, one or more user terminals (not shown), which may be, for example, mobile transceivers, modems, a wireless local area network (LAN), and the like. Similarly, the second network 14 may include a second base station (BTS-B) 24 coupled to the second network 14 by a link 26 that may be any type of link, as discussed above, the second network 14 and BTS-B 24 forming a second backhaul structure 27 belonging to Operator B. The BTS-B 24 may be coupled to an antenna 28 that may be, for example, disposed on a tower 30 belonging to Operator B. The operation of and communication between these network elements may be substantially similar as that of the network elements belonging to the first network 12, and will be discussed in more detail below. It is also to be appreciated that each of the first network 12 and the second network 14 may include any number of additional base station terminals and antennas located, for example on additional towers (not illustrated), and coupled via various links, as described above, and that such additional structures is intended to be within the scope of this disclosure.

In one example, the antennas 20 and 28 may be coupled to BTS-A 16 and BTS-B 24, respectively, via links 32. The links 32 may be any type of link, including, for example, microwave links, radio frequency (RF) cable links, communication over power lines, optical fiber, wireless optical links, coaxial cables, twisted pair cables, and the like. In some embodiments where the links 32 may be optical links (wireless or fiber), each antenna 20, 28 may include an antenna termination that may act to couple the antenna 20 to the optical links, as will be discussed in more detail below. Similarly, in these embodiments, BTS-A 16 and BTS-B 24 may include base station terminations to couple BTS-A 16 and BTS-B 24, to the optical links 32. The links 32 may act as a full duplex coupling between end network elements of the respective link.

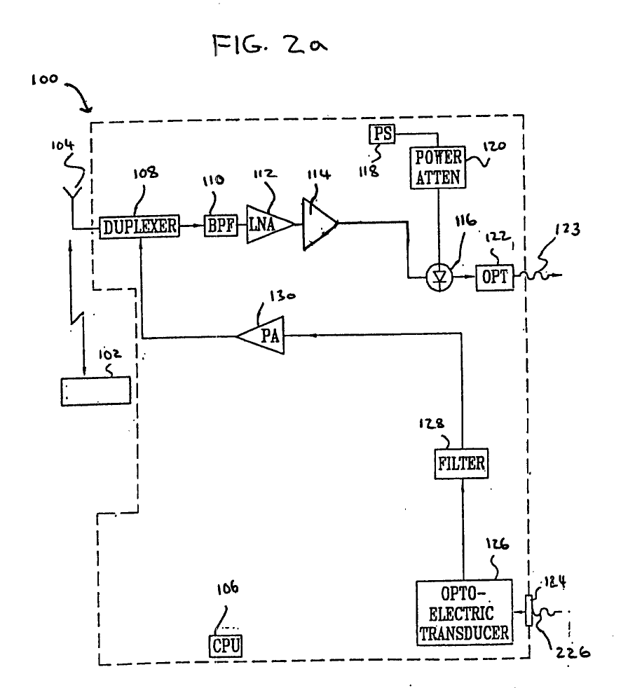

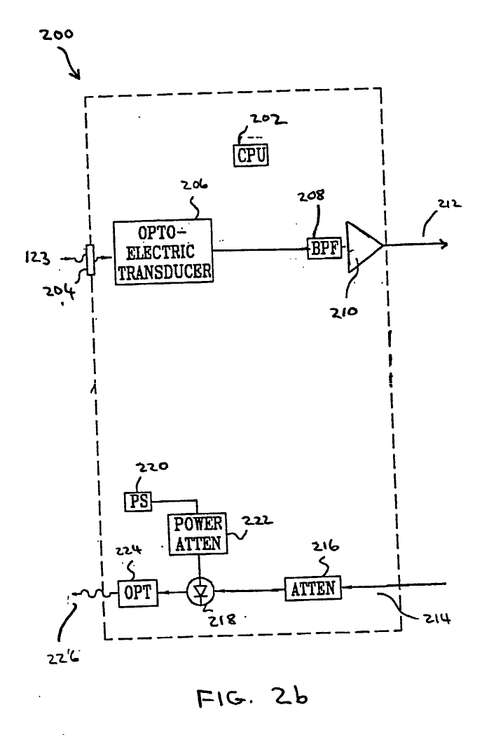

Referring to FIGS. 2a and 2b, there are illustrated schematic block diagrams of one example of antenna termination and base station termination circuitry according to aspects of the invention. As discussed above, when link 32 is an optical link, antenna 20 (see FIG. 1) may include an antenna termination, herein referred to as a microwave remote unit (MRU) 100 (illustrated in FIG. 2a), and BTS-A 16 may include a base station termination, herein referred to as a microwave donor unit (MDU) 200 (illustrated in FIG. 2b). Each of the MRU 100 and MDU 200 may include electro-optical circuitry to convert RF signals generated in or received by the associated network element to and from optical signals that are transmitted over the link 32. It is to be appreciated that while the following discussion of the MRU 100 and MDU 200 may be presented in terms of antenna 20 and BTS-A 16, the discussion applies equally and interchangeably to antenna 28 and BTS-B 24.

Referring to FIG. 2a, MRU 100 may act as a converter between RF and optical signals, the optical signals conveying signals between user terminals 102 and BTS-A 16 over link 32 (see FIG. 1). MRU 100 may comprise a central processing unit (CPU) 106 which may provide overall control for operational parameters of components within MRU 100, such as a supply voltage or a gain setting of a component. The MRU 100 may also comprise a duplexer 108 that may enable the RF antenna element 104 to both receive RF signals from and transmit RF signals to user terminals 102. The RF antenna element 104 may receive the uplink signal transmitted by a user terminal 102, and transfer the uplink signal to the duplexer 108. The uplink signal may be passed from the duplexer 108 to a band-pass filter (BPF) 110, which, according to some embodiments operates in a bandwidth for conveying uplink signals defined by a protocol under which shared network 10 operates, such as, for example, 824-849 MHz, and rejects signals at other frequencies. The filtered uplink signal from BPF 110 is amplified by a low noise amplifier (LNA) 112, and a second amplifier 114, which provide a total gain for the system, for example, on the order of 70 dB.

According to the illustrated example, the second amplifier 114 may transfer the uplink signal as a modulating signal to an optical emitter 116. According to some embodiments, the optical emitter 116 may comprise a solid state laser diode. Alternatively, the optical emitter 116 may be any other suitable electromagnetic wave emitter, known in the art, that emits waves, which may be modulated and detected. The modulation may be implemented as any type of analog or digital modulation, or combination thereof, known in the art. In some embodiments, the modulation may be applied using one or more sub-carriers, as is known in the art. The optical emitter 116 may be powered with a power supply (PS) 118 so that the average power output from the emitter is approximately constant. In another example, an attenuator 120 may be included to further control the power supplied to, and therefore output from, the optical emitter 116.

In one example, the optical emitter 116 may generate coherent radiation having a wavelength in an approximate range of 850 nanometers (nm)-1,550 nm at a power in an approximate range of 1-500 milliwatts (mW), or alternatively at any other convenient power level and wavelength. The radiation is collimated to a substantially parallel beam by transmission collimating optics 122. For example, if the optical emitter 116 comprises a laser diode, optics 122 may comprise a combination of one or more lenses and/or other optical components such as optical fibers, which are implemented by methods known in the art to collimate the generally diverging beam which radiates from the laser diode. According to one example, the collimated beam may have a divergence in an approximate range of 0.5-2.5 mrad. The collimated beam is transmitted as a free-space optical uplink signal 123, over the link 32 to MDU 200 at the BTS-A 16. In this example, the power emitted by the optical emitter 116 may be preferably less than a power level which causes deleterious effects when incident on a person. According to other embodiments or aspects, the link 32 may comprise an optical fiber, and optics 122 comprises coupling optics to the optical fiber. In this example, a higher transmit power may be possible.

Referring to FIG. 2b, the optical uplink signal 123 transmitted over the link 32 may be received by the MDU 200 at BTS-A 16. BTS-A 16 is coupled to MDU 200, which also acts as a converter between RF and optical radiation. MDU 200 may comprise a CPU 202 which may provide overall control for operational parameters of components within MDU 200. According to some embodiments, CPU 106 and/or CPU 202 may also generate management signals, as are known in the art, for the purpose of monitoring and/or controlling components of the link 32.

The optical uplink signal is received by receiving collimating optics 204 in MDU 200. Optics 204 focus the received radiation onto an opto-electric transducer 206 in MDU 200, which converts the radiation into electrical (RF) signals. The transducer 206 may also provide an initial pre-amplification stage for the RF signals. In the illustrated example, the pre-amplified RF signals are filtered by an isolating BPF 208 and amplified by a main amplifier 210. The amplifier 210 provides an output signal to BTS-A 16 on line 212. The output signal may be conveyed through BTS-A 16 to the first network 12.

Referring again to FIG. 2b, BTS-A 16 also supplies downlink signals to user terminals 102, via the link 32. According to some embodiments, the downlink signals may be in a frequency band 869-894 MHz, although any other suitable frequency band available in the communication protocol implemented in shared network 10 may be used. The downlink RF signals may be transferred, on line 214, to a variable attenuator 216, which sets a level of the RF signals so as to provide a suitable modulation depth for an optical emitter 218. The optical emitter 218 may be substantially similar in operation and implementation to the optical emitter 116 in the MRU 100, providing an electromagnetic wave output, which is modulated by one of the methods described above with respect to optical emitter 116. Thus, in some embodiments, the optical emitter 218 is powered with a power supply 220 so that the power output from the emitter is approximately constant, and in alternative embodiments, an attenuator 222 may be provided to further control the power output from optical emitter 218.

Radiation from optical emitter 218 is collimated by transmission collimating optics 224, which may be generally similar to optics 122 in the MRU. In one example, the optics 224 may be implemented, depending on optical emitter 218, so as to generate a beam having a divergence in an approximate range of 0.5-2.5 mrad, as discussed above. The radiation from optical emitter 218 is transmitted as a downlink optical signal 226 via link 32, which may be a wireless optical link and/or an optical fiber, as discussed above. The downlink optical signal 226 is received by receiving collimating optics 124 in MRU 100 (see FIG. 2a). Optics 124 focus the received radiation onto an opto-electric transducer 126 in MRU 100, which converts the radiation into electrical signals, thus recovering the electric signals provided by the BTS-A 16. According to some embodiments, opto-electric transducer 126 may be substantially similar in operation and implementation to opto-electric transducer 206, and may also provide a pre-amplification stage for the recovered electrical signals.

In the illustrated example, the recovered pre-amplified electrical signals are filtered and transferred via a filter 128, to a power amplifier (PA) 130. In other examples, filter 128 may not be present, and the recovered pre-amplified signals may be transferred directly to PA 130. PA 130 may serve to increase the power level to a suitable final output level for transmission to the user terminals 102. The amplified signals from PA 130 are transferred to duplexer 108, and then radiated from RF antenna element 104 to user terminals 102.

Thus, using the MRU 100 and MDU 200, the BTS-A 16 may communicate RF signals to and from user terminals over a wireless optical link, such as link 32.

Referring again to FIG. 1, according to one embodiment of the shared network 10, an operator, for example, Operator A, may add capacity and/or coverage to the first network 12 by placing one or more additional remote antennas on the infrastructure of another operator, for example, Operator B, and by connecting these antennas to the first network 12. For example, Operator A may place a remote antenna 34 on tower 30 belonging to Operator B. In one example, the remote antenna 34 may include an MRU 100 and may be coupled to BTS-A 16 via a wireless optical link 37. The remote antenna 34 may receive RF signals from any number of user terminals located within a coverage area of remote antenna 34, and may convert these RF signals into one or more optical signals that may be transmitted via the wireless optical link 37 to BTS-A 16.

According to another embodiment, each antenna 20 and 34 may include both an MRU 100 and an MDU 200, which may be combined, and referred to as a Symmetrical Donor Remote Unit (SDRU). The remote antenna 34 may convert RF signals received from one or more user terminals into one or more optical signals that may be transmitted via the wireless optical link 36 to the antenna 20 located on tower 22. In one example, the antenna 20 may convert the received optical signals into RF electrical signals, using an SDRU, and pass the electrical signals on to BTS-A 16 via link 32, which may be in this example, a non-optical link (e.g., a microwave link, a coaxial cable, a twisted pair cable, etc.). Alternatively, the antenna 20 may include optical pass through circuitry and may pass the optical signal received from the remote antenna 34 on to BTS-A 16 via link 32, which may be in this example, an optical link as discussed above.

It is to be appreciated that an optical transceiver, such as an SDRU or MRU, may be provided, for example, packaged or co-located with the antenna on tower 22, as illustrated. However, any of the components of the antenna 20 may be separated out from the antenna package 20 and provided as an independent unit, which is not part of the antenna 20. For example, referring to FIG. 2a, the RF antenna element 104 may be separated from the MRU 100 (or SDRU which may comprise and MRU 100 and an MDU 200), and connected to the MRU (or SDRU) using a coaxial cable, radio frequency (RF) links, optical fibers, or any other type of connection known in the art. In another example, the optical antenna elements 122 may be separated out, and located apart from the remainder of the circuitry. The optics 122 may similarly be connected to the remainder of the MRU or SDRU using any suitable connection. The same is true for any of the remote antennas 34 and 38 and antenna 28 belonging to Operator B.

Similarly, Operator B may place a remote antenna 38 on tower 22 belonging to Operator A, and may couple the remote antenna 38 to the second network 14 in any of the manners described above in reference to remote antenna 34. Thus, as discussed above in reference to remote antenna 34, the remote antenna 38 and/or antenna 28 may each include an MRU or an SDRU, the remote antenna 38 may include an MRU and the antenna 28 may include an optical pass through to optical link 32, or antenna 38 may include an MRU and BTS-B may include an MDU to create an optical link 39 between antenna 38 and BTS-B 24. Furthermore, it is to be appreciated that the system may also operate to provide signals from the networks to the user terminals, i.e., in a similar manner, remote antennas 34, 38 may receive an optical signal, for example, via link 36, and may convert the optical signal into RF signals to be broadcast to the user terminals.

It is also to be appreciated that although FIG. 1 illustrates the infrastructure of two operators being shared between the operators, that any number of operators may join in the shared network, and the infrastructure can be shared in any and all possible combinations. It is to further be appreciated that Operators A and B may be associated in some manner, for example, subsidiaries of a common parent company. Alternatively, Operators A and B may be competitors, and may offer each other mutual benefits in exchange for sharing of one another's infrastructures or may have any other relationship know to those in the industry.

According to another embodiment, antenna 28 (or antenna 20) may be a multiband or sectored antenna, and Operator B may allow Operator A (or Operator A may allow Operator B) to use one or more spare sectors or bands covered by antenna 28 (or antenna 20). Thus, for this embodiment Operator A (or Operator B) need not place its additional antenna 34 (or antenna 38) on tower 30 (or tower 22), and may instead couple a sector or band of antenna 28 (or antenna 20) to BTS-A 16 (or BS-B 24) via optical link 36, as described above.

One benefit of the above described methods and apparatus for sharing infrastructure is that each of Operators A and B may already have operating permits, licenses, and the like for their respective cell sites, and may have already completed construction of their respective infrastructures, including the towers 22 and 30. Therefore, each operator may add capacity to their respective networks by a relatively simply addition of a remote antenna or by making use of an unused sector of another operator, such as creating and coupling of that remote antenna or sector to the operator's existing network, as described above. This may be significantly more cost effective than constructing additional towers and building additional infrastructure. In addition, the system and methods described above allow each operator to reuse their existing backhaul equipment 17, 27 to communicate with the additional remote antenna or sector.

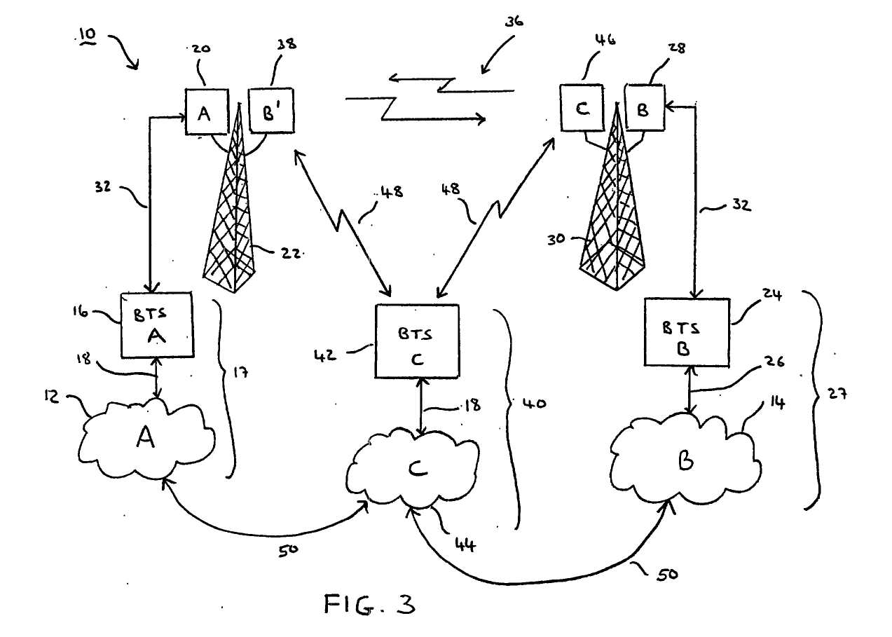

Referring to FIG. 3, there is illustrated a schematic block diagram of a portion of another embodiment of a shared network 10 according to aspects of the invention. It is to be appreciated that in FIG. 3 structure similar to that of FIG. 1 has been illustrated with like reference numbers and that, for the sake of brevity, the function of each device is not explicitly repeated. In this embodiment, an operator, for example, Operator C may allow another operator, for example, Operator B, to use its backhaul infrastructure 40, which may include a base station terminal (BTS-C) 42 and a third network 44, to communicate signals between the second network 14 and the remote antenna 38. In addition or alternatively, Operator B may allow Operator C to place a remote antenna 46 on its tower 30 belonging to Operator B, or may allow Operator C to use one or more spare sectors of the multi-sectored antenna 28 belonging to Operator B as, for example, described above. It is to be appreciated that according to any of the above-described embodiments and possible combinations, each operator can benefit from the mutual sharing of equipment and infrastructure among operators.

According to one embodiment, remote antenna 38 (belonging to Operator B) may be located on tower 22 belonging to Operator A. As discussed above, remote antenna 38 may include an MRU or SDRU (not shown), to convert RF signals to and from optical signals or to different RF frequency. Remote antenna 38 may communicate with BTS-C 42 via link 48, which may be, for example, a wireless optical link. Operation of wireless optical link 48 may be substantially the same as that of either of wireless optical links 32 or 36 described previously. BTS-C 42 may transfer signals received from the remote antenna 38 to the third network 44 of Operator C. The third network 44 may be linked to the second network 14 via a network link 50 that may allow the signals to be passed on to the second network 14 and processed by the second network 14, as though the remote antenna 38 were directly coupled to the second network 14.

It is to be appreciated that each of the links described herein and any of the embodiments or possible combinations described herein may be used to provide signals to be transmitted from a respective network through another Operator's respective backhaul structure and/or a wireless optical link to a remote antenna on another operators infrastructure for broadcasting to any number of user terminals (not illustrated). Thus, each of the links described herein may be used to add capacity by an operator without additional infrastructure.

For example, in a similar manner, the first network 12 may be linked to the third network 44 via a network link 50, allowing Operators A and C to share infrastructure in a similar manner as described above in reference to Operator B. The network link 50 may be any type of link, including but not limited to, a wireless link, a microwave link, a coaxial cable, a twisted pair cable, communication over a power line, communication over a cable television link, an optical fiber, etc..

An advantage of the above-described shared network is that each operator may add capacity to its network, thereby enhancing service to its user terminals, while sharing the cost of installing and operating backhaul structures and other network infrastructure, such as the towers. It is to be appreciated that the shared network described herein may accommodate any number of operators, and that each operator may deploy remote antennas (or utilize spare sectors of another operator's multiband, sectored antenna) on any one or more of the other operators' infrastructure. Thus, for example, Operator C may remotely deploy antennas on, and couple to, either one or both of Operator A's backhaul structure 17 and Operator B's backhaul structure 27. The same may be true for each additional operator.

Therefore, it is to be appreciated that according to one aspect of the invention, the infrastructure of any of Operators A, B or C may receive a signal from a remote antenna either directly over a communication link, for example a wireless optical link as discussed above, or via another operator's backhaul structure. It is also to be appreciated that a combination of communication links may be used, for example, a signal from a remote antenna belonging to Operator A (located for example on a tower belonging to Operator C) may be transmitted via a wireless optical link (such as link 36, see FIG. 1) to Operator B's backhaul structure, and the signal may then be transmitted via a network link from Operator B's network to Operator A's network.

It is to be understood that shared network 10, and each of networks 12 and 14, may operate according to one or more industry standard multiplexing systems, such as time division multiple access (TDMA), frequency domain multiple access (FDMA), and/or code division multiple access (CDMA), or any other standard or contemplated standard to be used in the art, and in some embodiments the remote antennas, e.g. 20, 34, may operate in a radio frequency (RF) band that may be allocated for cellular communications.

Furthermore, a redundant, RF back-up link may be provided for each of the links 36, 37, 39 and 48 described above. Thus, if the optical link is broken, for example, due to poor weather conditions, communication may still be established between the remote antennas and respective base stations using the redundant RF links. In one example, these redundant RF links may operate at approximately 5.8 GHz, but any frequency may be used, as desired by the operators.

Having thus described various illustrative embodiments and aspects thereof, modifications and alterations may be apparent to those of skill in the art. For example, the towers belonging to Operators A and B need not be a traditional tower, but may be, for example, a rooftop of a building, a steeple, a billboard, or another site suitable for locating an antenna. Furthermore, the user terminals and base stations may generate many different types of signals to be transmitted by the antennas, for example, cellular signals, LAN signals, bluetooth, 802.11b signals etc., and different types of signals may be transmitted in different directions over the links. For example, a base station may transmit cellular signals to a remote antenna located in a building, and the remote antenna may transmit LAN, bluetooth, 802.11b, data, and the like signals as “backhaul” to the base station for the operator to distribute into a network, such as, for example, the Internet. In addition, an operator, for example, Operator A, may allow another operator to share its BTS-A, in a manner similar to that described above regarding sharing of a sector of an antenna. Furthermore, in some embodiments, one or more of the base stations may be replaced by a wireless LAN server or hub. Such modifications and alterations are intended to be included in this disclosure, which is for the purpose of illustration only, and is not intended to be limiting. The scope of the invention should be determined from proper construction of the appended claims, and their equivalents.

What is claimed is:

1. A method for adding capacity to a first network, the method comprising acts of:
operating a first remote antenna of a first operator on an infrastructure of a second operator;
transmitting and receiving a wireless signal with the first remote antenna;
transmitting a first signal to the first remote antenna from a first infrastructure of the first operator and providing the first signal from the first remote antenna to the first infrastructure.

2. The method as claimed in claim 1, wherein the act of transmitting and providing the first signal includes transmitting an optical signal via a wireless optical link between the first infrastructure and the first remote antenna.

3. The method as claimed in claim 1, wherein the act of transmitting and providing the first signal includes providing the first signal over a coaxial cable.

4. The method as claimed in claim 1, wherein the act of transmitting and providing the first signal includes providing the first signal over an optical fiber.

5. The method as claimed in claim 1, wherein the act of transmitting and providing the first signal includes providing the first signal over an RF link.

6. The method as claimed in claim 1, further comprising an act of converting the wireless signal to the first signal at the first remote antenna.

7. The method as claimed in claim 1, wherein the act of operating the first remote antenna includes using a sector of a sectored antenna of the second operator.

8. The method as claimed in claim 1, wherein the act of operating the first remote antenna includes using a band of a mulitband antenna of the second operator.

9. The method as claimed in claim 1, wherein the act of providing the first signal from the first remote antenna includes acts of:
transmitting the first signal from the first remote antenna to a second backhaul structure of the second operator via a second communication link;
transmitting the second signal from the second backhaul structure to a first network of the first operator via a network link; and
receiving the second signal with the first network of the first operator.

10. The method as claimed in claim 1, wherein the act of transmitting the first signal to the first remote antenna comprises acts of:
transmitting the first signal via a network link to a network of a third operator;
transmitting the first signal from the network to the first remote antenna via a wireless optical link between the network of the third operator and the first remote antenna.

11. A shared network comprising:
a first infrastructure of a first operator;
a second infrastructure of a second operator;
a first remote antenna of the first operator operated on the second infrastructure and coupled to the first infrastructure by a communication link.

12. The shared network as claimed in claim 11, wherein the communication link includes a wireless optical link between the first remote antenna and the first infrastructure.

13. The shared network as claimed in claim 11, wherein the second infrastructure includes a cellular tower.

14. The shared network as claimed in claim 11, further comprising a second remote antenna of the second operator operated on the first infrastructure and coupled to the second infrastructure by the communication link.

15. The shared network as claimed in claim 11, wherein the first infrastructure comprises first backhaul structure including a first base station terminal and a first network.

16. The shared network as claimed in claim 15, wherein the communication link comprises a network link between the first network and a second backhaul structure of the second infrastructure; and
a wireless optical link between the second backhaul structure and the first remote antenna.

17. The shared network as claimed in claim 11, wherein the network link includes an RF link.

18. The shared network as claimed in claim 11, wherein the network link includes an optical fiber.

19. The shared network as claimed in claim 11, further comprising a third infrastructure of a third operator, and wherein the communication link include a wireless optical link between the first remote antenna and the third infrastructure and a network link between the third infrastructure and the first infrastructure.

20. The shared network as claimed in claim 11, wherein the first remote antenna comprises a sector of a sectored antenna of the second operator.

21. The shared network as claimed in claim 11, wherein the first remote antenna comprises a band of a multiband antenna of the second operator.
